(19) United States
(12) Patent Application Publication
(10) Pub. No.: US 2024/0421348 A1
(43) Pub. Date: Dec. 19, 2024

(54) ANODE MIXTURE, METHOD FOR PRODUCING ANODE MIXTURE AND ALL SOLID STATE BATTERY

(71) Applicant: TOYOTA JIDOSHA KABUSHIKI KAISHA, Toyota-shi (JP)

(72) Inventors: Koji KAWAMOTO, Miyoshi-shi (JP); Naohiko ITAYAMA, Osaka (JP)

(73) Assignee: TOYOTA JIDOSHA KABUSHIKI KAISHA, Toyota-shi (JP)

(21) Appl. No.: 18/733,011

(22) Filed: Jun. 4, 2024

(30) Foreign Application Priority Data
Jun. 13, 2023 (JP) 2023-096767

(51) Int. Cl. H01M 10/0562; H01M 4/02; H01M 4/36; H01M 4/587

(52) U.S. Cl. CPC H01M 10/0562; H01M 4/366; H01M 4/587; H01M 2004/027; H01M 2300/008

(57) ABSTRACT

A main object of the present disclosure is to provide an anode mixture capable of suppressing an increase in resistance. The present disclosure achieves the object by providing an anode mixture used for an all solid state battery, the anode mixture comprising a coated anode active material and a sulfide solid electrolyte, wherein the coated anode active material comprises an anode active material and a coating layer covering at least a portion of the surface of the anode active material, and the coating layer contains a borohydride solid electrolyte containing LiBH₄ and LiX, wherein X is selected from Cl, Br and I.

### TECHNICAL FIELD

The present disclosure relates to an anode mixture, a method for producing an anode mixture, and an all solid state battery.

### BACKGROUND ART

An all solid state battery is a battery having a solid electrolyte layer between a cathode active material layer and an anode active material layer, and has an advantage of facilitating simplification of the safety device as compared with a liquid-based battery having a liquid electrolyte containing a combustible organic solvent. Among them, an all solid state battery using sulfide based solid electrolyte has been actively studied in recent years because of its high-ionic conductivity and good formability. Further, for the purpose of improving the conductivity of solid electrolyte, studies have been conducted in which additional components are added.

For example, Patent Literature 1 discloses a solid electrolyte containing sulfide solid electrolyte and LiBH₄ in which LiX is dissolved, and an all solid state battery containing the solid electrolyte. Patent Literature 2 also discloses a method for producing an all solid state battery that contains a borohydride compound as a solid electrolyte.

However, in an all solid state battery, there are problems such as improvement of cycling life and improvement of power, and in addition to improvement of ionic conductivity of solid electrolyte, countermeasures such as reduce of resistance of electrode layers and reduction of deterioration of materials are also required.

### CITATION LIST

### Patent Literatures

Patent Literature 1: Japanese Patent Application Laid-Open (JP-A) No. 2016-134316
Patent Literature 2: International Publication No. 2019/078130

### SUMMARY OF DISCLOSURE

### Technical Problem

In this regard, although a sulfide solid electrolyte exhibits good ionic conductivity, it is susceptible to reduction, and a degradation layer may be formed on an anode active material in contact with the sulfide solid electrolyte, which may lead to increased resistance.

The present disclosure has been made in view of the above circumstances, and an object of the present disclosure is to provide an anode mixture capable of suppressing an increase in resistance.

### Solution to Problem

[1]

An anode mixture used for an all solid state battery, the anode mixture comprising a coated anode active material and a sulfide solid electrolyte,
wherein the coated anode active material comprises an anode active material and a coating layer covering at least a portion of the surface of the anode active material, and the coating layer contains a borohydride solid electrolyte containing LiBH₄ and LiX, wherein X is selected from Cl, Br and I.

[2]

The anode mixture according to [1], wherein the coated anode active material contains graphite as the anode active material.

[3]

The anode mixture according to [1] or [2], wherein in the coated anode active material, a ratio of the borohydride solid electrolyte to the sum of the anode active material and the borohydride solid electrolyte is 0.8% by volume or more and 22% by volume or less.

[4]

The anode mixture according to any one of [1] to [3], wherein in the coated anode active material, a ratio of the borohydride solid electrolyte to the sum of the anode active material and the borohydride solid electrolyte is 1.5% by volume or more and 15% by volume or less.

[5]

The anode mixture according to any one of [1] to [4], wherein the borohydride solid electrolyte contains LiCl as the LiX.

[6]

The anode mixture according to any one of [1] to [5], wherein the anode mixture comprises an argyrodite-type sulfide solid electrolyte as the sulfide solid electrolyte.

[7]

A method for producing the anode mixture according to any one of [1] to [6], the method comprising: a coating step of obtaining the coated anode active material, and a mixing step of obtaining the anode mixture by mixing the coated anode active material and the sulfide solid electrolyte, wherein
the coating step includes:
a precursor layer forming process forming the precursor layer by coating a surface of the anode active material with a precursor solution containing the LiBH₄ and the LiX and drying the anode material coated with the precursor solution; and
a coating layer forming process forming the coating layer containing the borohydride solid electrolyte by heating the precursor layer.

[8]

An all solid state battery comprising a cathode active material layer, an anode active material layer, and a solid electrolyte layer disposed between the cathode active material layer and the anode active material layer, wherein
the anode active material layer comprises the anode mixture according to any one of [1] to [6].

### Advantageous Effects of Disclosure

The present disclosure provides an anode mixture capable of suppressing an increase in resistance.

### BRIEF DESCRIPTION OF DRAWINGS

FIG. 1 is a schematic cross-sectional view illustrating a coated anode active material in the present disclosure.

FIG. 2 is a schematic cross-sectional view illustrating an all solid state battery in the present disclosure.

FIGS. 3A and 3B are graphs showing the relationship between amount of the coating material and capacity retention ratio in Examples 1 to 4 and Comparative Example 1.

### DESCRIPTION OF EMBODIMENTS

Hereinafter, anode mixture, method for producing, and all solid state battery in the present disclosure will be described in detail.

### A. Anode Mixture

Anode mixture used in all solid state battery includes a coating anode active material and a sulfide solid electrolyte. The coating anode active material includes an anode active material and a coating layer covering at least a part of anode active material, and coating layer includes solid electrolyte borohydride including LiBH₄ and LiX (X is selected from Cl, Br or I). In the present disclosure, solid electrolyte borohydride in coating layer may be referred to as solid electrolyte A (SE-A), and sulfide solid electrolyte in anode mixture may be referred to as solid electrolyte B (SE-B). In addition, the term “surface” of anode active material as used herein includes not only the outer surface of anode active material (anode active material particles), but also a part that can be contacted with a liquid such as a precursor solution described later.

Since coating layer covering anode active material contains a predetermined solid electrolyte borohydride, anode mixture can be suppressed from increasing the resistivity.

As described above, although sulfide solid electrolyte has good ionic conductivity, it is easily reduced and deteriorated layers may be formed on anode active material while battery is repeatedly charged and discharged. In contrast, the disclosed anode mixture contains a predetermined coating anode active material. The coating anode active material is coated with a solid electrolyte borohydride-containing coating layer having good reduction resistance. Therefore, even if battery is repeatedly charged and discharged, the deterioration layers can be suppressed from being formed, the resistivity can be suppressed from increasing, and the cyclability of battery can be improved. In addition, since the coating anode active material and sulfide solid electrolyte having good ionic conductivity are contained, anode mixture can be suppressed. Further, when the deteriorated layer is formed, the migration of carrier ions such as Li ions may be inhibited and the ion conductivity may be lowered, but in anode mixture disclosed herein, the formation of the deteriorated layer is suppressed, and thus the deterioration in the ion conductivity can be suppressed.

### 1. Coated Anode Active Material

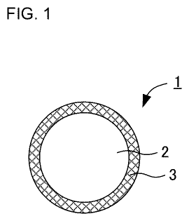

FIG. 1 is a schematic cross-sectional view illustrating a coated anode active material according to the present disclosure. As shown in FIG. 1, the coating anode active material 1 includes an anode active material 2 and a coating layer 3 that covers at least a part of the surface of anode active material. Coating layer 3 contains a predetermined solid electrolyte borohydride.

### (1) Anode Active Material

Anode active material is not particularly limited as long as it functions as an anode active material in battery. Examples of anode active material include carbon-based active materials such as natural graphite, artificial graphite, graphene, hard carbon, and soft carbon, oxide active materials such as Nb₂O₅, Li₄Ti₅O₁₂ and SiO, and metal active materials such as In alone, Al alone, Si alone, Sn alone, and alloys of these metals. Among these, graphite is preferable. In addition, anode active material may be only one type or may be two or more types.

The form of anode active material is, for example, particulate. Anode active material may be a primary particle or a secondary particle.

The mean particle diameter (D₅₀) of anode active material is, for example, equal to or greater than 10 nm, may be equal to or greater than 100 nm, may be equal to or greater than 500 nm, may be equal to or greater than 1 μm, or may be equal to or greater than 5 μm. Meanwhile, the mean particle diameter (D₅₀) of anode active material is, for example, 50 μm or less, may be 40 μm or less, may be 30 μm or less, may be 25 μm or less, or may be 20 μm or less. Mean particle size (D₅₀) refers to the cumulative 50% particle size in the volume-based particle size distribution by the laser diffractive particle size distribution analyzer. The average particle diameter (D₅₀) may be the average particle diameter of the primary particles or the average particle diameter of the secondary particles. Mean particle size (D₅₀) refers to the cumulative 50% particle size in the volume-based particle size distribution by the laser diffractive particle size distribution analyzer.

### (2) Coating Layer

Coating layer contains solid electrolyte borohydride which covers at least part of the surface of anode active material and contains LiBH₄ and LiX (X is selected from Cl, Br or I). Although the “surface” is as described above, coating layer usually covers at least a part of the outer surface of anode active material.

Solid electrolyte borohydride has, for example, a structure represented by αLiBH₄—LiX (X is at least one selected from Cl, Br and I). α is, for example, a number of 1 or more and 5 or less, and X is as described above. In particular, solid electrolyte borohydride is preferably represented by 3LiBH₄—LiX:

Solid electrolyte borohydride may contain only one of LiCl, LiBr and LiI as LiX, or may contain two or more thereof. In particular, solid electrolyte borohydride preferably contains LiCl as LiX. For example, when the boronated solid electrolyte contains two or more kinds of LiX, the ratio of LiCl in all LiX is preferably 50% or more.

Solid electrolyte borohydride is preferably a solid solution of LiBH₄ and LiX.

Coating layer may be a layer containing only the borohydride solid electrolyte as a material, or may be a layer containing other materials. The ratio of solid electrolyte borohydride among all the materials constituting coating layer is preferably 50% or more.

Coating layer may cover a portion of the top surface of anode active material or may cover the entire surface. The coverage may be, for example, 10% or more, 30% or more, 50% or more, 70% or more, or 90% or more. On the other hand, the coverage may be 100% or less than 100%. In the latter case, the coverage may be, for example, 99% or less, 97% or less, 95% or less, or 93% or less.

The mean thickness of coating layer is, for example, equal to or greater than 5 nm, may be equal to or greater than 50 nm, or may be equal to or greater than 100 nm. Meanwhile, the mean thickness of coating layer may be, for example, less than or equal to 1000 nm, less than or equal to 500 nm, or less than or equal to 300 nm.

The coverage and the mean thickness can be determined, for example, by microscopic observation by scanning electron microscopy (SEM) and by XPS (X-ray photoelectron spectroscopy).

In the coating anode active material, the ratio of solid electrolyte borohydride to the sum of anode active material and solid electrolyte borohydride is, for example, 0.8% by volume or more, may be 1.5% by volume or more, may be 4% by volume or more, or may be 7% by volume or more. On the other hand, the ratio is, for example, 22% by volume or less, may be 18% by volume or less, may be 15% by volume or less, or may be 11% by volume or less. In the present specification, the above-described ratio can also be referred to as “coating material amount”.

When the amount of the coating material is expressed on a weight basis, the amount of the coating material is, for example, 0.5% by weight or more, may be 1% by weight or more, may be 3% by weight or more, or may be 5% by weight or more. On the other hand, the dressing material amount, for example, is 15 weight % or less, may be 12 weight % or less, may be 10 weight % or less, it may be 7 weight % or less.

Here, coating layer may cover the surface of the primary particles of anode active material, or may cover the surface of the secondary particles in which the primary particles of anode active material are aggregated. When the coating anode active material is a secondary particle, coating layer may cover both the primary particle and the secondary particle of anode active material. Solid electrolyte borohydride can be considered to be arranged on the surface (the surface of the secondary particles) and inside (the surface of the primary particles) of the coating anode active material. Coating layer is preferably directly coated with anode active material.

### (3) Coated Anode Active Material

The form of the coating anode active material is, for example, particulate. The coating anode active material may be a primary particle or a secondary particle. The mean particle size (D₅₀) of the coating anode active material is, for example, not less than 10 nm and not more than 50 micrometers. The average particle diameter may be the average particle diameter of the primary particles or the average particle diameter of the secondary particles. The mean particle size (D₅₀) is as described above.

The percentage of the coating anode active material in anode mixture is, for example, 40% by volume or more, may be 50% by volume or more, or may be 70% by volume or more. On the other hand, the percentage of the coating anode active material is, for example, 90% by volume or less, and may be 80% by volume or less.

The process for producing the coating anode active material will be described later.

### 2. Sulfide Solid Electrolyte

Sulfide solid electrolyte is usually a solid electrolyte containing sulphur(S) as a main component of an anionic element.

Examples of the sulfide solid electrolyte may include a solid electrolyte containing a Li element, an X element (X is at least one kind of P, As, Sb, Si, Ge, Sn, B, Al, Ga, and In), and a S element. Also, the sulfide solid electrolyte may further include at least one of an O element and a halogen element. Examples of the halogen element may include F element, Cl element, Br element, and I element. Sulfide solid electrolyte may be glass (amorphous), glass-ceramic, or crystalline.

As sulfide solid electrolyte in the present disclosure, in particular argyrodite sulfide solid electrolyte is preferred. By “argyrodite-type sulfide solid electrolyte” is meant a sulfide solid electrolyte having an argyrodite-type crystal phase. Whether or not crystal phase has an argyrodite type can be confirmed by, for example, X-ray diffraction measurement (XRD measurement). In addition, in the argyrodite-type sulfide solid electrolyte, it is preferable to have the argyrodite-type crystal phase as a main phase.

The composition of the aldilodite-type sulfide solid electrolyte is not particularly limited, and examples thereof include Li_{7-y}PS_{6-y}X′_{y} (X′ is a halogen element, and y is a number satisfying 0≤y≤2).

Sulfide solid electrolyte preferably has a higher ionic conductivity. The ionic conductivity at 25° C. is, for example, 0.5×10⁻³ S/cm or more, may be 1×10⁻³ S/cm or more, or may be 2×10⁻³ S/cm or more.

Examples of the shapes of sulfide solid electrolyte include particulate shapes. The mean particle diameter (D₅₀) of sulfide solid electrolyte is, for example, 10 nm or more and 50 micrometers or less. The mean particle size (D₅₀) is as described above.

The ratio of sulfide solid electrolyte in anode mixture is, for example, 10% by volume or more, may be 30% by volume or more, or may be 50% by volume or more. On the other hand, the ratio of sulfide solid electrolyte is, for example, 60% by volume or less.

### 3. Anode Mixture

Anode mixture may further include at least one of a conductive material and a binder.

Examples of the conductive material may include a carbon material, metal particles, conductive polymer. Carbon materials include, for example, particulate carbon materials such as acetylene black (AB) and Ketjen black (KB), and fibrous carbon materials such as carbon fibers, carbon nanotubes (CNT), and carbon nanofibers (CNF). Examples of the binder include fluorine contain binders such as polyvinylidene fluoride (PVDF) and polytetrafluoroethylene (PTFE), rubber-based binders such as butadiene rubber, and acrylic-based binders.

Anode mixture may be an anode slurry including a dispersing medium. Examples of the dispersion medium include organic solvents such as butyl butyrate, dibutyl ether, heptane, and tetrahydrofuran. Anode slurry can be applied to a substrate such as current collector and dried to form anode active material layers that contain anode mixture. On the other hand, anode mixture may not contain a dispersing medium.

Anode mixture in the present disclosure is usually used for anode active material layers in all solid state battery. All solid state battery is described in “C. all solid state battery”.

### B. Method for Producing Anode Mixture

Method for producing of anode mixture has a predetermined coating step and a mixing step.

### 1. Coating Step

The coating step is a step of obtaining the coating anode active material described above, and includes a predetermined precursor-layer forming process and an coating layer forming process.

### (1) Precursor Layer Forming Process

The precursor layer forming process is a process of forming a precursor layer by coating a precursor solution including LiBH₄ and LiX on anode active material and drying anode active material coated with the precursor solution.

Precursor solutions can be prepared by mixing a solvent containing LiBH₄ and a solvent containing LiX in a desired ratio of LiBH₄ and LiX, as described in the Examples below. Examples of the solvent include an organic solvent such as tetrahydrofuran (THE).

The coating method is not particularly limited, and examples thereof include a method in which anode active material is immersed in a precursor solution and stirred. Further, the drying conditions such as the drying temperature and the drying time are not particularly limited as long as the solvent can be removed from the precursor solution. For example, the drying temperature is 80° C. or more and 100° C. or less, and the drying time is, for example, 5 minutes or more and 1 hour or less.

In coating layer forming process described below, the coating and drying may be repeated a plurality of times to form a coating layer having a desired thickness and coverage.

### (2) Coating Layer Forming Process

Coating layer forming process according to the present disclosure is a process of forming a coating layer by heating the precursor layers. Coating layer is the same as the content described in the “A. anode mixture”, and therefore the description thereof will be omitted.

The heating temperature and the heating time are not particularly limited as long as the desired coating layer can be formed. The heating temperature is, for example, 80° C. or more and 150° C. or less, and the heating time is, for example, 30 minutes or more and 2 hours or less. Further, the heating may be performed under a reduced pressure environment such as vacuum.

### (3) Coated Anode Active Material

The coating anode active material is the same as the content described in “A. anode mixture”, and therefore the description thereof will be omitted.

### 2. Mixing Step

The mixing step is a step of mixing the coating anode active material and sulfide solid electrolyte layers to obtain anode mixture.

The percentage of coating anode active material and sulfide solid electrolyte is the same as described in “A. anode mixture”. In the mixing step, the coating anode active material and sulfide solid electrolyte may be mixed with at least one of the conductive material and the binder in the presence of a dispersing medium. Conductive materials, binders, and dispersing media are the same as described in “A. anode mixture”. The mixing method is not particularly limited, and may be a conventionally known method.

### 3. Anode Mixture

Anode mixture produced by the above-described method is the same as the content described in “A. anode mixture”, and therefore the description thereof will be omitted.

### C. All Solid State Battery

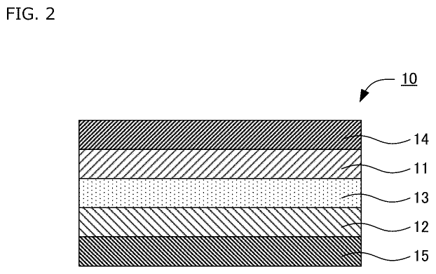

FIG. 2 is a schematic cross-sectional view illustrating a all solid state battery according to the present disclosure. All solid state battery 10 shown in FIG. 2 has a cathode active material layer 11, an anode active material layer 12, and a solid electrolyte layer 13 formed between cathode active material layer 11 and anode active material layer 12, and anode active material layer 12 contains anode mixture described above. All solid state battery 10 includes a cathode current collector 14 that collects current in cathode active material layer 11 and an anode current collector 15 that collects current in anode active material layer 12.

In all solid state battery disclosed herein, anode active material layers contain the above-described anode mixture, so that all solid state battery has a good charge-capacity retention ratio.

### 1. Anode Active Material Layers

Anode active material layers contain anode mixture described above. Anode mixture is the same as the content described in the “A. anode mixture”, and therefore the description thereof will be omitted. The thickness of the anode active material layer is, for example, 0.1 μm or more and 1000 μm or less.

### 2. Cathode Active Material Layers

Cathode active material layers contain at least cathode active material. Cathode active material layers preferably contain at least one of solid electrolyte, a conductive material, and a binder, if desired. Examples of cathode active material, the conductive material, and the binder include conventionally known materials. Cathode active material layers preferably contain sulfide solid electrolyte described above as solid electrolyte. The thickness of the cathode active material layer is, for example, 0.1 μm or more and 1000 μm or less.

### 3. Solid Active Material Layer

Solid electrolyte layers contain at least solid electrolyte and may optionally contain binders. The binder is as described above. Solid electrolyte is preferably sulfide solid electrolyte described above. The thickness of the solid electrolyte layer is, for example, 0.1 μm or more and 1000 μm or less.

### 4. Cathode Current Collector and Anode Current Collector

The materials of cathode current collector and anode current collector can be, for example, conventionally known metallic materials such as Al, SUS, Cu and Ni.

### 5. All Solid State Battery

All solid state battery is typically a lithium-ion secondary battery. Applications of all solid state battery include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used for a power supply for driving a hybrid electric vehicle (HEV), a plug-in hybrid electric vehicle (PHEV), or a battery electric vehicle (BEV). All solid state battery may be used as a power source for a moving object (for example, a railroad, a ship, or an airplane) other than vehicles, or may be used as a power source for an electric appliance such as an information processing device.

Note that the present disclosure is not limited to the above-described embodiment. The above-described embodiment is an example, and any one having substantially the same configuration as the technical idea described in the claims in the present disclosure and having the same operation and effect is included in the technical scope of the present disclosure.

### EXAMPLES

### Example 1

### (Preparation of Coating Anode Active Material)

The tetrahydrofuran (THF) solution containing LiBH₄ and THE solution containing LiI were mixed so that the moles of LiBH₄ and LiI were 3:1. Thus, a precursor solution (THE solution including 3LiBH₄—LiI) was prepared. The precursors were then added to anode active material (spherical natural graphite, particle size 16 solutions) and dried on an 80° C. hotplate several times. Thus, the amount of the coating material (SE-A/(graphite+SE-A)) was adjusted to be as shown in Table 1. Thereafter, vacuum drying was performed at 120° C. for 1 hour. A coated anode active material (coated graphite) was thus prepared.

### (Preparation of Anode Mixture)

Aldirodite-type sulfide based solid electrolyte (SE-B) was added to the coated graphite, and these were carefully mixed in a mortar. An anode mixture was thus prepared. The content of the argyrodite-type sulfide based solid electrolyte was adjusted so that the content of anode mixture was as shown in Table. 1.

### (Production of Evaluation Battery)

As an evaluation battery (anode half-cell), a green compact cell with a cylindrical non-conductive ceramic guide having a 11.28 mm inner diameter and a stainless-steel current collector was produced. Specifically, anode mixture was put into the ceramic guide so that the graphite content was 8 mg, and 0.1 g argyrodite-type sulfide based solid electrolyte was put into the ceramic guide and pressed with a 588 MPa to prepare an anode active material layer and a separator layer. Then, a In—Li foil was disposed as a counter electrode on the separator layer, and further pressed with a 98 MPa. After that, it was restrained by a restraining jig. Thus, a battery for evaluating was prepared.

### Examples 2 to 4

Evaluation battery was prepared in the same manner as in Example 1, except that coating anode active material and anode mixture were prepared so that coating material amounts and anode mixture were as shown in Table 1.

### Comparative Example 1

A coated anode active material was prepared in the same manner as in Example 1, except that in the preparation of the coating solid electrolyte (3LiBH₄—LiI) instead of borohydride sulfide was used. A battery for evaluation was prepared in the same manner as in Example 1, except that anode mixture was prepared using the coating anode active material so as to have the composition shown in Table 1.

### Comparative Example 2

Spherical natural graphite was used instead of anode active material. An anode mixture was prepared by carefully mixing graphite, 3LiBH₄—LiI, and an argyrodite-type sulfide based solid electrolyte together using a mortar so that anode mixture had the ratios shown in Table. 1. That is, the coated graphite was not prepared. Evaluation battery was prepared in the same manner as in Example 1, except that the above anode mixture was used.

### [Evaluation]

### (Impedance Measurement and Capacity Retention Measurement)

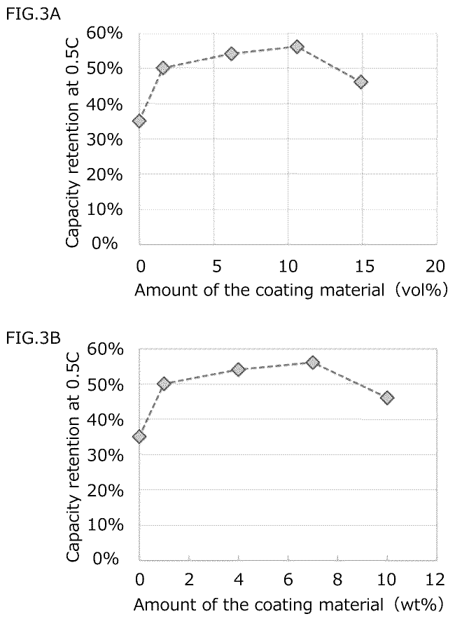

Cell resistance and charge capacity retention were evaluated for battery of Examples 1-4 and Comparative Examples 1-2 as follows. Results are shown in Table 2, and FIG. 3A-3B.

First, 1C current was set as a 2.72 mA/cm², and 0.1C-CCCV, 1.5-0.05V (v.s.Li⁺/Li) was charged and discharged at 25° C. for three cycles (finished charge and discharge). After that, it was charged to 1.1 mAh, and impedance was measured in the frequency range of the voltage-width 10 mV, 7 MHz˜0.01 Hz at 25° C., and the initial resistance was measured.

Next, charge/discharge was performed for 20 cycles under the conditions of 60° C., 1.5-0.05V (v.s.Li⁺/Li), and 0.1C-CCCV, and then impedance was measured under 1.1 mAh charge conditions. The resistance increase rate was calculated from the resistance after 20 cycles and the initial resistance.

Battery for evaluating the resistivity increasing rate was subjected to a charge rate test under the conditions of 0.1, 0.2, and 0.3 at 25° C., 1.5-0.05V (v.s.Li⁺/Li), a CC charge of 0.5C, and a CCCV discharge of 0.1C. The charge capacity retention rate in 0.5C was calculated based on 0.1C charge capacity.

TABLE 1

| | Amount of | | Composition of |
|---|---|---|---|
| | the coating | | the anode mixture |
| | material SE-A/ | | graphite/ |
| | (graphite + SE-A) | | SE-A/SE-B |
| | wt(%) | vol(%) | (vol %) |
| Example 1 | 7 | 10.6 | 50.0/5.9/44.1 |
| Example 2 | 4 | 6.2 | 50.0/3.3/46.7 |
| Example 3 | 1 | 1.6 | 50.0/0.8/49.2 |
| Example 4 | 10 | 14.9 | 50.0/8.8/41.2 |
| Comparative | 0 | 0 | 50.0/0/50.0 |
| Example 1 | | | |
| Comparative | — | — | 50.0/5.9/44.1 |
| Example 2 | | | |

TABLE 2

| | Cell resistance | | Resistance | Capacity |
|---|---|---|---|---|
| | (Ω) | | increase | retention |
| | | After | rate | rate |
| | Initial | cycles | (%) | (%) |
| Example 1 | 25.09 | 26.65 | 6 | 56 |
| Example 2 | 27.96 | 28.75 | 3 | 54 |
| Example 3 | 28.41 | 31.27 | 10 | 50 |
| Example 4 | 30.17 | 32.05 | 6 | 46 |
| Comparative | 26.65 | 41.67 | 56 | 35 |
| Example 1 | | | | |
| Comparative | 29.47 | 36.11 | 23 | 43 |
| Example 2 | | | | |

As shown in Table 2, the resistance increase rate was remarkably suppressed and the capacity retention rate was also good in each of the Examples as compared with Comparative Examples 1 and 2. In addition, it was confirmed from Table 2 and the results of Examples 1 to 4 shown in FIGS. 3A and 3B that a better capacity retention ratio can be obtained by adjusting the coating material amounts (wt % and vol %).

### Examples 5 and 6

Coating anode active material was prepared using the coating material shown in Table 3 (solid electrolyte borohydride: SE-A) and the coating material quantity was as shown in Table 3. An anode mixture and an evaluation battery were prepared and evaluated in the same manner as in Example 1 except that the coating anode active material was used. The results are shown in Table 3. In Example 6, the resistance increase rate was negative, but the resistance increase rate was set to 0% for convenience.

TABLE 3

| | | Amount of the | | Cell resistance | | Resistance | Capacity |
|---|---|---|---|---|---|---|---|
| | Coating | coating material | | (Ω) | | increasing | retention |
| | material | SE-A/(graphite + SE-A) | | | After | rate | rate |
| | (SE-A) | wt(%) | vol(%) | Initial | cycles | (%) | (%) |
| Ex. 5 | 3LiBH₄-LiBr | 5.9 | 10.6 | 25.66 | 31.08 | 21 | 50 |
| Ex. 6 | 3LiBH₄-LiCl | 4.5 | 10.6 | 23.34 | 22.59 | 0 | 61 |

From Examples 1, 5, and 6, when 3LiBH₄—LiCl was used as the coating material, the resistivity increasing rate was suppressed most, and the capacity retention rate was also good.

### Comparative Example 3 to Comparative Example 5

The uncoated graphite and solid electrolyte borohydride (SE-A) shown in Table 4 were mixed in a mortar at the ratio shown in Table 4 to produce an anode mixture. A battery for evaluating was prepared in the same manner as in Example 1 except that anode mixture was used. Initial resistance was measured for the prepared battery in the manner described above. The results are shown in Table 4.

TABLE 4

| | | Composition of | |
|---|---|---|---|
| | | the anode mixture | Initial cell |
| | | graphite/SE-A | resistance |
| | SE-A | (vol %) | (Ω) |
| Comparative | 3LiBH₄-LiI | 50/50 | 41.9 |
| Example 3 | | | |
| Comparative | 3LiBH₄-LiBr | | 45.0 |
| Example 4 | | | |
| Comparative | 3LiBH₄-LiCl | | 40.4 |
| Example 5 | | | |

From Comparative Example 2 and Comparative Examples 3 to 5, it was confirmed that sulfide solid electrolyte can be used for anode mixture to suppress the initial-resistance.

As a result, it was confirmed that the use of anode mixture of the present disclosure can suppress an increase in resistance, and a all solid state battery having a good capacitance retention ratio can be obtained.

### REFERENCE SIGNS LIST

1 Coated anode active material
2 Anode active material
3 Coating layer
10 All solid state battery
11 Cathode active material layer
12 Anode active material layer
13 Solid electrolyte layer
14 Cathode current collector
15 Anode current collector

What is claimed is:

1. An anode mixture used for an all solid state battery, the anode mixture comprising a coated anode active material and a sulfide solid electrolyte,
wherein the coated anode active material comprises an anode active material and a coating layer covering at least a portion of the surface of the anode active material, and the coating layer contains a borohydride solid electrolyte containing LiBH₄ and LiX, wherein X is selected from Cl, Br and I.

2. The anode mixture according to claim 1, wherein the coated anode active material contains graphite as the anode active material.

3. The anode mixture according to claim 1, wherein in the coated anode active material, a ratio of the borohydride solid electrolyte to the sum of the anode active material and the borohydride solid electrolyte is 0.8% by volume or more and 22% by volume or less.

4. The anode mixture according to claim 1, wherein in the coated anode active material, a ratio of the borohydride solid electrolyte to the sum of the anode active material and the borohydride solid electrolyte is 1.5% by volume or more and 15% by volume or less.

5. The anode mixture according to claim 1, wherein the borohydride solid electrolyte contains LiCl as the LiX.

6. The anode mixture according to claim 1, wherein the anode mixture comprises an argyrodite-type sulfide solid electrolyte as the sulfide solid electrolyte.

7. A method for producing the anode mixture according to claim 1, the method comprising: a coating step of obtaining the coated anode active material, and a mixing step of obtaining the anode mixture by mixing the coated anode active material and the sulfide solid electrolyte, wherein
the coating step includes:
a precursor layer forming process forming the precursor layer by coating a surface of the anode active material with a precursor solution containing the LiBH₄ and the LiX and drying the anode material coated with the precursor solution; and
a coating layer forming process forming the coating layer containing the borohydride solid electrolyte by heating the precursor layer.

8. An all solid state battery comprising a cathode active material layer, an anode active material layer, and a solid electrolyte layer disposed between the cathode active material layer and the anode active material layer, wherein
the anode active material layer comprises the anode mixture according to claim 1.
